(19) United States
(12) Patent Application Publication
(10) Pub. No.: US 2011/0072090 A1
(43) Pub. Date: Mar. 24, 2011

(54) METHOD AND SYSTEM FOR NAVIGATING EMAIL

(76) Inventors: Lisa Seacat DeLuca, San Francisco, CA (US); Kulvir S. Bhogal, Pflugerville, TX (US); Timothy J. Eby, Austin, TX (US); Samuel I. Ward, Austin, TX (US)

(21) Appl. No.: 12/565,069

(22) Filed: Sep. 23, 2009

(51) Int. Cl. G06F 15/16; G06F 17/30

(52) U.S. Cl. 709/206; 707/E17.01

(57) ABSTRACT

A method and computer program product for providing an email navigation tool includes receiving, on an email server, an email thread including a sequence of email messages. A sender of each email message in the sequence of email messages is identified. At least one sender file associated with at least one identified sender of the email messages in the sequence of email messages is identified. The sender file is configured to provide a visual identification of the identified sender. A sequence of sender files is generated from the at least one sender file. The sequence of sender files has an order corresponding to an order of the sequence of email messages. The sequence of sender files is displayed on a computer display.

### BACKGROUND OF THE INVENTION

This disclosure relates to email and, more particularly, to methods and computer program products for relating to navigation of email.

Email has become a very popular form of communication. It provides a quick and easy way to instantaneously convey information to people. Email also provides email users with the ability to reply to messages, and carry on conversations in email strings or threads. For example, if an email user sends an email to one or more recipients, the recipients may reply to the email. There may be multiple replies from the recipients and/or sender that create a series of related email messages. The series may be referred to as an email string or email thread.

Email clients may typically display individual email messages. However, some email clients may also display email threads. For example, an email client may group email messages having a common subject line, or another common field, and display them as a group. Displaying email threads as an alternative to displaying individual email messages may provide a user with a way to view related emails.

If an email user sends a message to multiple recipients, or if multiple recipients reply to an email, it can create a long email threads with many recipients and many senders. Long email threads may be difficult or cumbersome to navigate, particularly if an email user wishes to find a particular email, or emails from a particular sender within the email thread.

### BRIEF SUMMARY OF THE INVENTION

In an embodiment, a method of navigating email includes receiving, on an email server, an email thread including a sequence of email messages. A sender of each email message in the sequence of email messages is identified. At least one sender file associated with at least one identified sender of the email messages in the sequence of email messages is identified. The sender file is configured to provide a visual identification of the identified sender. A sequence of sender files is generated from the at least one sender file. The sequence of sender files has an order corresponding to an order of the sequence of email messages. The sequence of sender files is displayed on a computer display.

One or more of the following features may be included. The sender file may be an icon representing the at least one identified sender, a photo of the at least one identified sender, a symbol representing the at least one identified sender, and/or a media file representing the at least one identified sender. At least one of sender files may be replaced with a replacement sender file. The replacement sender file may be configured to provide a visual identification of the at least one identified sender.

Each email message in the sequence of email messages may include common text in a subject line of each email message.

At least one sender file in the sequence of sender files may be associated with an action. The action may be performed in response to selection of the sender file. The sender associated with the at least one selected sender file may be identified email messages from the sequence of email messages sent by the sender may be displayed.

In another embodiment, a method of navigating email includes receiving, on an email client, an email thread including a sequence of email messages. A sender of each email message in the sequence of email messages is identified. At least one sender file associated with at least one identified sender of the email messages in the sequence of email messages is identified. The sender file is configured to provide a visual identification of the identified sender. A sequence of sender files is generated from the at least one sender file. The sequence of sender files has an order corresponding to an order of the sequence of email messages. The sequence of sender files is displayed on a computer display.

One or more of the following features may be included. The sender file may be an icon representing the at least one identified sender, a photo of the at least one identified sender, a symbol representing the at least one identified sender, and/or a media file representing the at least one identified sender. At least one of sender files may be replaced with a replacement sender file. The replacement sender file may be configured to provide a visual identification of the at least one identified sender.

Each email message in the sequence of email messages may include common text in a subject line of each email message.

At least one sender file in the sequence of sender files may be associated with an action. The action may be performed in response to selection of the sender file. The sender associated with the at least one selected sender file may be identified email messages from the sequence of email messages sent by the sender may be displayed.

In another embodiment, a computer program product for navigating email is stored on a computer readable medium. The computer program product has a plurality of instructions, which, when executed by a processor, cause the processor to perform operations including receiving, on an email device, an email thread including a sequence of email messages. A sender of each email message in the sequence of email messages is identified. At least one sender file associated with at least one identified sender of the email messages in the sequence of email messages is identified. The sender file is configured to provide a visual identification of the identified sender. A sequence of sender files is generated from the at least one sender file. The sequence of sender files has an order corresponding to an order of the sequence of email messages. The sequence of sender files is displayed on a computer display.

One or more of the following features may be included. The sender file may be an icon representing the at least one identified sender, a photo of the at least one identified sender, a symbol representing the at least one identified sender, and/or a media file representing the at least one identified sender. At least one of sender files may be replaced with a replacement sender file. The replacement sender file may be configured to provide a visual identification of the at least one identified sender.

Each email message in the sequence of email messages may include common text in a subject line of each email message.

At least one sender file in the sequence of sender files may be associated with an action. The action may be performed in response to selection of the sender file. The sender associated with the at least one selected sender file may be identified email messages from the sequence of email messages sent by the sender may be displayed.

The email device may be an email client device and/or an email server device.

### BRIEF DESCRIPTION OF THE SEVERAL VIEWS OF THE DRAWINGS

FIG. 1 is diagrammatic view of a email navigation process coupled to a distributed computing network.

FIG. 2 is a flowchart view of an email navigation process.

FIG. 3 is a user interface view of an email thread.

FIG. 4 is a table view of email users and associated images.

FIG. 5 is a user interface view of an email display.

FIG. 6 is a user interface view of an email display.

Like references in the drawings denote like elements.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium may be a computer readable signal medium or a computer readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Note that the computer-readable storage medium could even be paper or another suitable medium upon which a program is printed, as the program can be electronically captured, via, for instance, optical scanning of the paper or other medium, then compiled, interpreted, or otherwise processed in a suitable manner, if necessary, and then stored in a computer memory. In the context of this document, a computer-readable storage medium may be any medium that can contain, or store a program for use by or in connection with an instruction execution system, apparatus, or device.

A computer readable signal medium may include a propagated data signal with computer-usable program code embodied therein, for example, in baseband or as part of a carrier wave. Such a propagated signal may take any of a variety of forms, including, but not limited to, electro-magnetic, optical, or any suitable combination thereof, A computer readable signal medium may be any computer-readable medium that can contain, store, communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

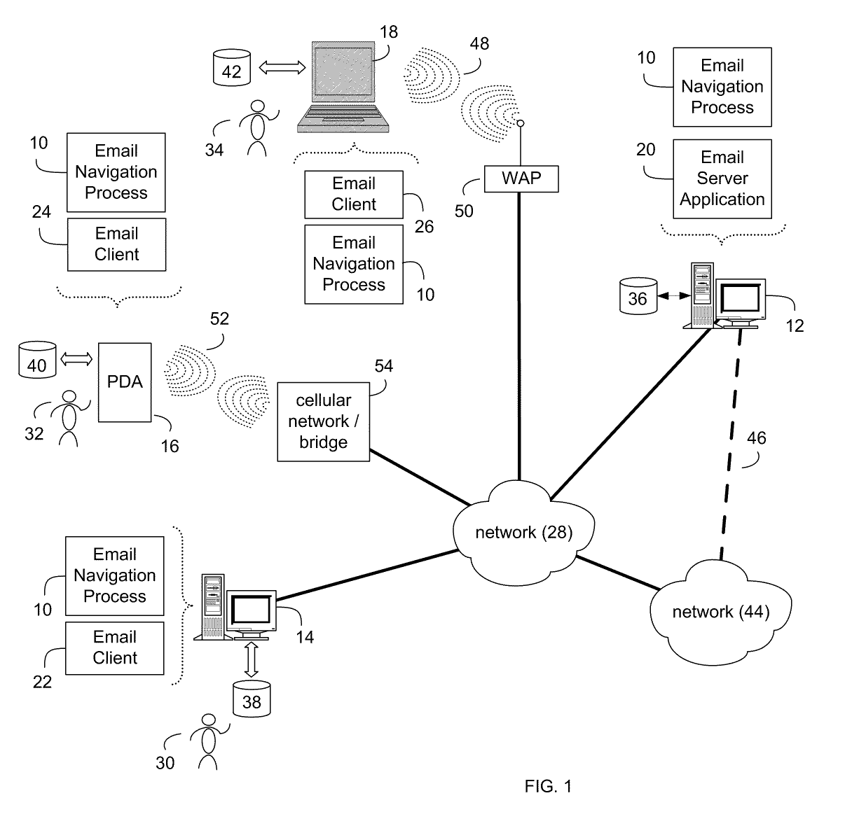

FIG. 1 depicts a computing infrastructure within which email navigation process 10 may reside. Email navigation process 10, for example, may reside on and may be executed by email server 12, which may be connected to network 28 (e.g., the Internet or a local area network). Examples of email server 12 may include, but are not limited to: a personal computer, a server computer, a series of server or personal computers, a mini computer, and a mainframe computer. Email navigation process 10 may also reside on and may be executed by one or more email devices, e.g. client electronic devices or server electronic devices such as email server 12, computer 14, personal digital assistant (PDA) 16, and/or laptop 18, and the like.

FIG. 1 also depicts email server application 20, which may reside on and may be executed by email server 12; and email client applications 22, 24, 26, which may reside on and may be executed by computer 14, PDA 16, and laptop 18, respectively. Various electronic devices, including email server 12, computer 14, PDA 16, and laptop 18, may also be connected to network 28, as shown.

Email server application 20 may be an instance of an email server that provides email services to users 30, 32, 34, for example. Server application 20 may be, for example, a mail transfer agent (MTA) application, examples of which include, but are not limited to: a Lotus® Domino® mail server, a Microsoft® Exchange® server, and a Gmail® webmail service. (Lotus and Domino are registered trademarks of International Business Machines Corporation in the United States, other countries, or both. Microsoft and Exchange are registered trademarks of Microsoft Corporation in the United States, other countries, or both. Gmail is a registered trademark of Google Incorporated in the United States, other countries, or both).

Email client applications 22, 24, 26 may be email client applications that allow users 30, 32, 34 to access their email, for example. Examples of email client applications 22, 24, 26 may include, but are not limited to: a Microsoft Outlook® application or a Lotus Notes® application, for example. (Outlook is a registered trademark of Microsoft Corporation in the United States, other countries, or both. Lotus Notes is a registered trademark of International Business Machines Corporation in the United States, other countries, or both). Email client applications 22, 24, 26 may also be web-based email interfaces executed or displayed by a web browser. For example, email client applications 22, 24, 26 may be a Gmail interface executed by or displayed in an Internet Explorer® browser, a Firefox browser, or a Chrome™ browser, for example. (Internet Explorer is a registered trademark of Microsoft Corporation in the United States, other countries, or both. Firefox is a registered trademark of the Mozilla Foundation in the United States, other countries, or both).

As will be discussed below in greater detail, email navigation process 10 may receive, on an email server and/or email client, an email string including a sequence of email messages. A sender of each email message in the sequence of email messages may be identified. At least one sender file associated with at least one identified sender of the email messages in the sequence of email messages may also be identified. The at least one sender file may be configured to provide a visual identification of the sender. Email navigation process 10 may generate a sequence of sender files from the at least one sender file. The sequence of sender files may have an order corresponding to an order of the sequence of email messages. The sequence of sender files may also be displayed on a computer display.

Email server 12, computer 14, PDA 16, and laptop computer 18 may run network operating systems, examples of which may include but are not limited to: Microsoft Windows XP® Server; Novell® Netware®; or Redhat® Linux®, for example (Windows XP is a registered trademark of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

The instruction sets and subroutines of email navigation process 10, which may include one or more software modules and one or more sets of software instructions, and which may be stored on storage device 36 coupled to email server 12, may be executed by one or more processors (not shown) and one or more memory architectures (not shown) incorporated into email server 12. The instruction sets and subroutines of email navigation process 10 may also be stored on storage devices 38, 40, and 42, and may be executed by one or more processors (not shown) and one or more memory architectures (incorporated into computer 14, PDA 16, and/or laptop 18. Storage devices 36, 38, 40, 42 may include but are not limited to: hard disk drives; solid state drives; tape drives; optical drives; RAID arrays; random access memory (RAM); and a read-only memory (ROM).

The instruction sets and subroutines of email navigation process 10, email server application 20, and email client applications 22, 24, 26 may be generated through the use of a compiler, such as the IBM XL compiler, the Visual Studio® compiler, or an assembler, for example (Visual Studio is a registered trademark of Microsoft Corporation in the United States, other countries, or both). The instruction set and subroutines may also be generated as scripts, such as JavaScript® scripts, or as other types of software code (Java and all Java-based trademarks and logos are trademarks of Sun Microsystems, Inc. in the United States, other countries, or both). In general, and as is known in the art, the instruction sets and subroutines of email navigation process 10, email server application 20, and email client applications 22, 24, 26 may be generated via any method of generating instruction sets and subroutines that may be executed by a processor.

As mentioned, various client electronic devices may be coupled to network 28. Examples of client electronic devices may include, but are not limited to: email server 12, computer 14, PDA 16, laptop 18, a data-enabled, cellular telephone (not shown), and a dedicated network device (not shown). One or more users (e.g., users 30, 32, 34) may access the various tools and applications, such as email navigation process 10, email server application 20, and/or email client applications 22, 24, 26 from any device connected to network 28 or directly from the device on which the tool or application resides.

Various computer devices and/or client electronic devices may be coupled directly to network 28, or may be indirectly coupled to network 28 through network 44. For example, email server 12 may be indirectly connect to network 28 through secondary network 44, as illustrated by phantom link line 46.

The various client electronic devices may be directly, indirectly, and/or wirelessly coupled to network 28 (or network 44). For example, email server 12 is shown directly coupled to network 28 via a hardwired network connection. Laptop 18 is shown wirelessly coupled to network 28 via wireless communication channel 48 established between laptop 18 and wireless access point (i.e., WAP) 50, which is shown directly coupled to network 28. WAP 50 may be, for example, an IEEE 802.11a, 802.11b, 802.11g, Wi-Fi, and/or Bluetooth device that is capable of establishing wireless communication channel 48 between laptop 18 and WAP 50. PDA 16 is shown wirelessly coupled to network 28 via cellular communication channel 52 and cellular network/bridge 54, which is shown directly coupled to network 28.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

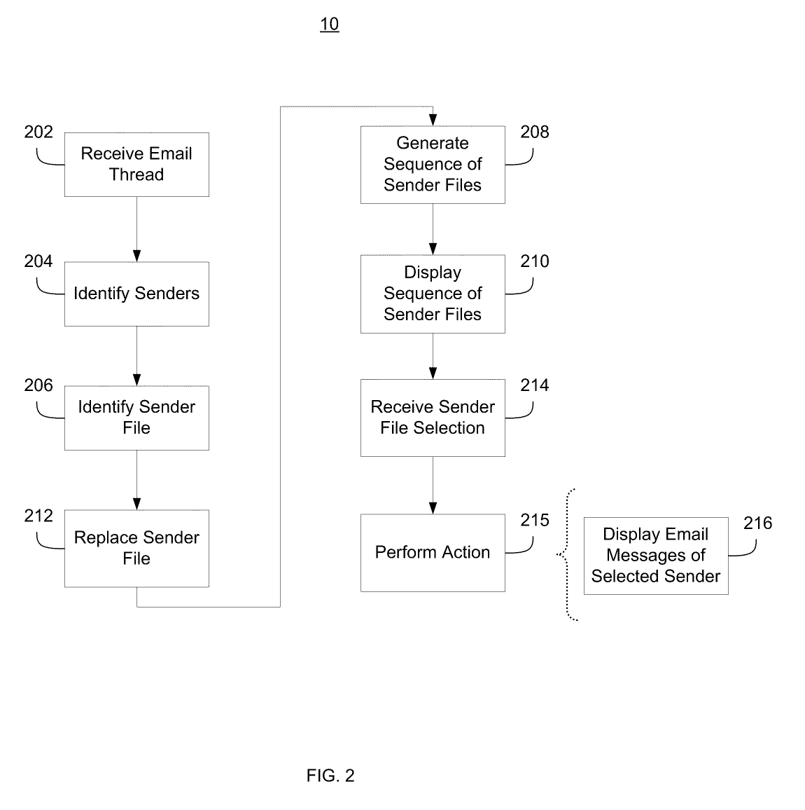

Referring to FIG. 2, email navigation process 10 may receive 202 an email string that includes a sequence of email messages, identify 204 a sender of each email message in the sequence of email messages, and identify 206 one or more sender files associated with the senders of the email messages. Email navigation process 10 may also generate 208 a sequence of sender files from the at least one sender file and display 210 the sequence of sender files on a display.

As will be discussed below, email navigation process 10 may also replace 212 a sender file with another file. Replacing 212 a sender file may include substituting an alternate file for the sender file, for example. If, for example, a user selects an alternate sender file, email navigation process 10 may receive 214 the selection of the sender file, and perform 215 an action. Performing 215 an action may include displaying 216 one or more email messages sent by the selected sender.

An email thread (or email string) may be a series of related emails. As is known in the art, as email users send and reply to email messages, email servers (e.g. email server application 20) and/or email clients (e.g. email client applications 22, 24, 26) may associate the related email messages and replies. Email servers and clients may append previous emails to email replies, thus creating a string or thread of emails beginning with the original email and ending with the most recent replies, for example. When multiple users reply to an email string, these email strings and threads may become long. As is known in the art, a string or thread of emails may be appended in any order. Also, a string or thread of emails need not include appended messages; the email messages may be associated or related in some other way, such as association by a common subject line, for example. Email server and client applications may associate email messages in a string or thread through various means including, but not limited to, association by common subject lines, sender addresses, recipient addresses, or other information, for example.

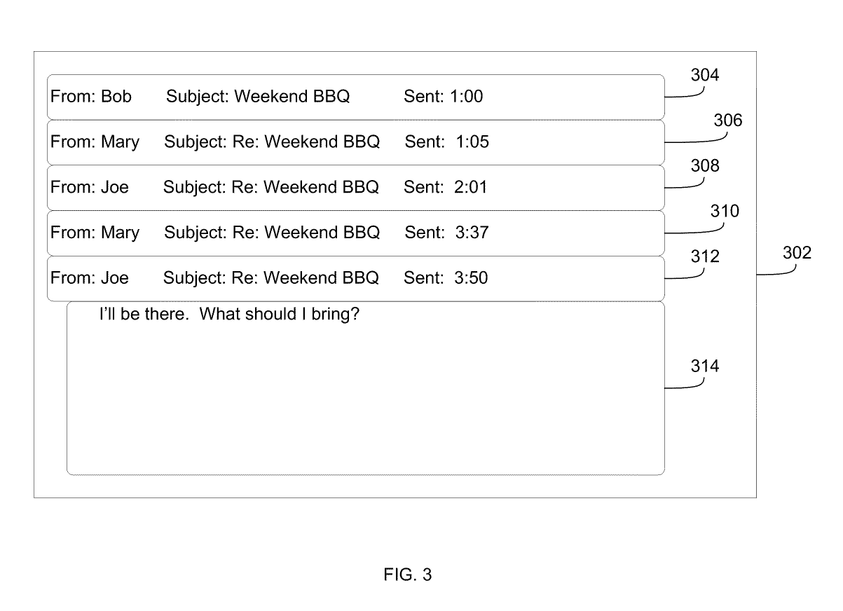

When email navigation process 10 receives 202 an email string, the email string may be a sequence of email messages associated in any appropriate manner. The email string may be a complete email string, or may be a portion or subset of a larger email string. As an example, FIG. 3 includes email string 302, which includes a series or sequence of email messages sharing a common subject line. The email messages in email string 302 may also be replies to original email message 304, for example. Although FIG. 3 depicts email messages associated by a common subject line, the email messages may be associated as an email string in various ways. For example, the email messages may be associated by a common sender, common recipients, common “CC” recipients, common “BCC” recipients, common text, common header information, common email body information, or any other commonality between the email messages.

Email messages within an email string may also be ordered or sorted. Email string 302 shows email messages sorted by the time they were sent. In this example, original email message 304 was sent at 1:00. The subsequent emails, namely emails 306, 308, 310, 312, were sent at 1:05, 2:01, 3:37, and 3:50, respectively. As shown, the email messages in email string 302 are ordered or sorted according to the time sent. In FIG. 3, email body 314 is shown as the body of email message 312. While the bodies of email messages 304, 306, 308, 310, and 312 are not shown in FIG. 3, in other embodiments email messages 304, 306, 308, 310 may be displayed in their entirety.

Email navigation process 10 may identify 204 a sender of each email message in the email string 302. Each email message may, for example, include information about the sender of the email message. Information about the sender may be included in a sender field, for example. If email string 302 is a series of appended messages, information about the sender(s) may be found within the text of the email messages. The information about the sender may be the sender's email address, the sender's name, the sender's network address, or any other information that can identify the sender of the email message. If any or all of the email messages within email string 302 contain information about email sender(s), email navigation process 10 may identify any or all senders of email messages within email string 302.

Email string 302 shows an email string that may have three senders. In email string 302, Bob is the sender of original email message 304, Mary is the sender of email messages 306, 310, and Joe is the sender of email messages 308, 314. Original email message 304 may contain information that identifies Bob as the sender. For example, original email message 304 may include Bob's name, Bob's email address, or any other information that may unambiguously identify Bob as the sender of the email Likewise, email messages 306, 310 may contain information that identifies Mary as the sender, and email messages 308, 312 may contain information that identifies Joe as the sender. Email navigation process 10 may identify 204 the senders of email messages 304-312 using the information contained in email messages 304-314.

Email navigation process 10 may also identify 206 at least one sender file associated with the senders of email messages 304-312. A sender file may be an image, such as a picture, symbol, or other visual image, configured to identify a sender of an email message. For example, a sender file may be a picture of the sender, or a sender file may be a symbol, word, phrase, or icon associated with the sender. A sender file may also be a multimedia file, such as a video file (e.g. an AVI file, an MPEG file, a FLASH video file, or the like), an audio file (e.g. a WAV file, an MP3 file, or the like), or any other kind of multimedia file.

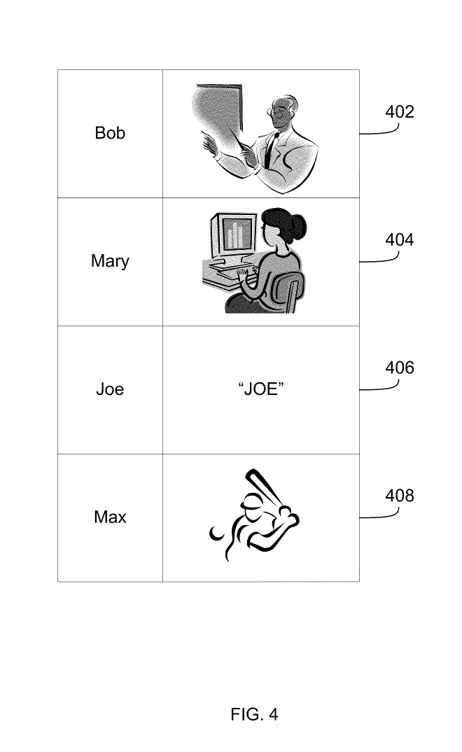

FIG. 4 shows a table of email senders and associated sender files. In FIG. 4, sender file 402 may be a photographic image of sender Bob. Accordingly, the table in FIG. 4 shows email sender Bob and sender file 402 in the same row. Likewise, sender file 404 may be a photographic image of Mary and is shown associated with email sender Mary. However, sender files need not be photographic images; sender files may be any visual symbol, word, picture, or image that can be associated with an email user. For example, sender file 406 is the word “JOE,” which is shown as associated with email sender Joe. Likewise, sender file 408 is an icon or symbol of a baseball player. Sender file 408 is shown as associated with email sender Max.

Although FIG. 4 shows email senders and sender files associated in a table, email navigation process 10 may associate email senders and sender files via any appropriate mechanism. For example, email navigation process 10 may associate email senders and sender files in a table, a file, a class, an XML document, a hashtable, an array, a database, or any other method of associating data.

Email navigation process 10 may identify 206 sender files associated with the users who sent email messages. As discussed, email navigation process 10 may identify 204 Mary, Joe, and Bob as the senders of email messages in email string 302. Since FIG. 4 shows sender file 402 associated with Bob, sender file 404 associated with Mary, and sender file 406 associated with Joe, email navigation process 10 may identify 206 sender files 402, 404, 406 as sender files associated with senders of the email messages in email string 302.

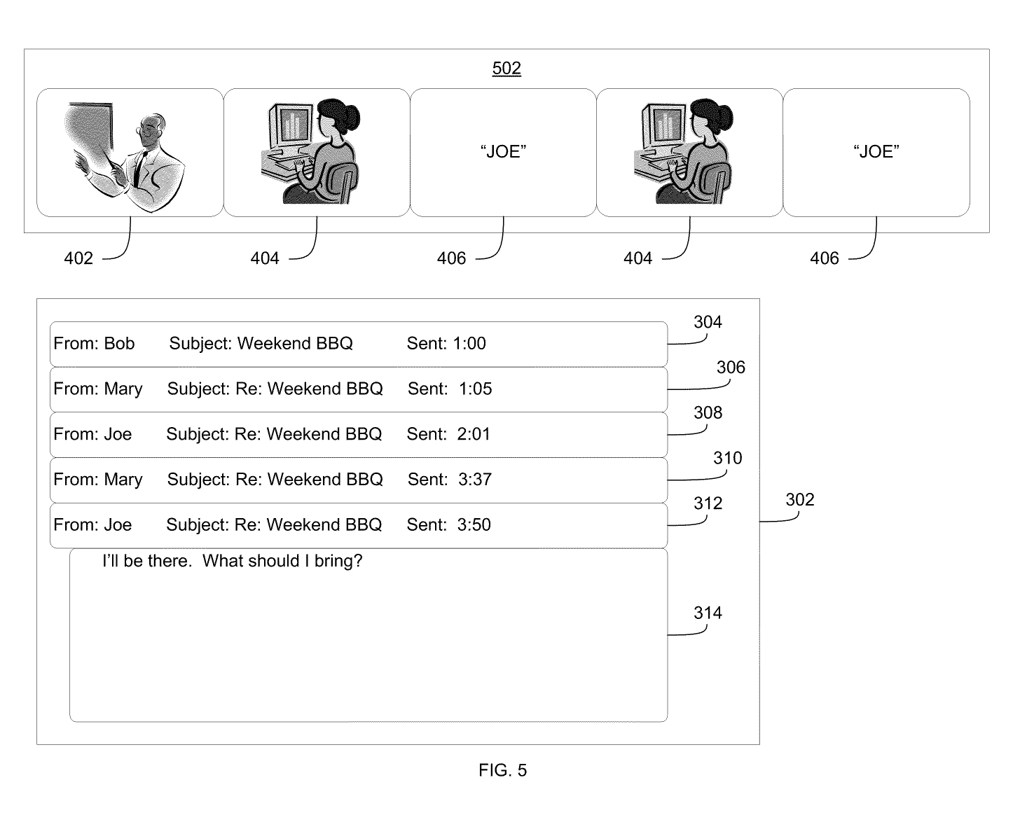

Email navigation process 10 may also generate 208 a sequence of sender files from the at least one sender file. The sequence of sender files may be a series of sender files corresponding to the users who sent the email messages in the email string. The sequence of sender files may have an order that corresponds to the order of email messages in the email string. Referring to FIG. 5, the email messages in email string 302 have an order corresponding to the time the email messages were sent. Consequently, the users who sent the email (listed in the “From” field in email messages 304-312) have an order corresponding to the time the messages were sent. In this example, the order of the email senders is: Bob (email message 304), Mary (email message 306), Joe (email message 308), Mary (email message 310), and Joe (email message 312).

Accordingly, email navigation process 10 may generate a sequence of email sender files corresponding to the email senders in email string 302. The sequence of email sender files may be arranged in the same order as the email senders in email string 302. For example, FIG. 5 shows sequence of sender files 502. Since the order of email senders in email sequence 302 is: Bob, Mary, Joe, Mary, Joe; sequence of sender files 502 may include sender files in the order of: Bob, Mary, Joe, Mary, Joe.

Email navigation process 10 may display 210 the sequence of sender files 502 on a display, such as a computer screen, television, computer projector, or the like. For example, a recipient of email string 302 may wish to view the email string on his/her computer. Email navigation process 10 may display 210 email string 302 along with sequence of sender files 502 on the recipient's computer monitor, for example. In an embodiment, email navigation process 10 may display 210 sequence of sender files 502 separate from email string 302. For example, email navigation process 10 may display 210 sequence of sender files 502 adjacent to, next to, above, or below email string 302. Email navigation process 10 may also display 210 sequence of sender files 502 without also displaying email string 302, for example. Email navigation process 10 may display 210 sequence of sender files 502 as a static image, an interactive image, a toolbar, a window, a desktop object, or any other type of user interface element on a display. Additionally/alternatively, if a sender file is a multimedia file (such as an audio or video file), email navigation process 10 may play the multimedia file. Playing the multimedia file may include playing the multimedia file once, playing the multimedia file multiple times, and/or playing the multimedia file over and over in a loop. Displaying 210 sequence of sender files 502 may provide an email user with a visual representation of the senders of, and order of, email messages within email string 302.

In one embodiment, email navigation process 10 may also replace 212 a sender file with another image. For example, an email sender or email recipient may wish to use an alternate sender file to identify an email sender. Turning to FIG. 4, email sender Max may be a baseball fan. If Max's original sender file is a photographic picture of Max or the textual phrase “Max,” email sender Max, or another email user, may wish to replace Max's sender file with an alternate sender file that depicts a baseball player, such as sender file 408. Email navigation process 10 may provide features that allow Max, or another email user, to replace Max's original sender file with sender file 408. In this example, email navigation process 10 may then replace 212 Max's original sender file with sender file 408.

Email navigation process 10 may replace 212 the sender file on the email sending side, or on the email receiving side. For example, an email recipient, e.g. user 30, may specify that email sender Max should be associated with sender file 408. In this example, whenever user 30 receives an email from Max, email navigation process 10 may replace 212 Max's original sender file with sender file 408. Additionally/alternatively, an email sender, e.g. Max, may specify that Max's image should be associated with sender file 408. In this example, whenever Max sends an email, email navigation process 10 may replace 212 Max's original sender file with sender file 408 for each recipient of Max's email.

Email navigation process 10 may receive 214 a selection of a sender file. If, for example, a user selects a sender file, email navigation process 10 may receive 214 the selection, and may display 216 the email messages sent by the selected sender. In this way, a user may be able to filter emails from a particular sender, for example.

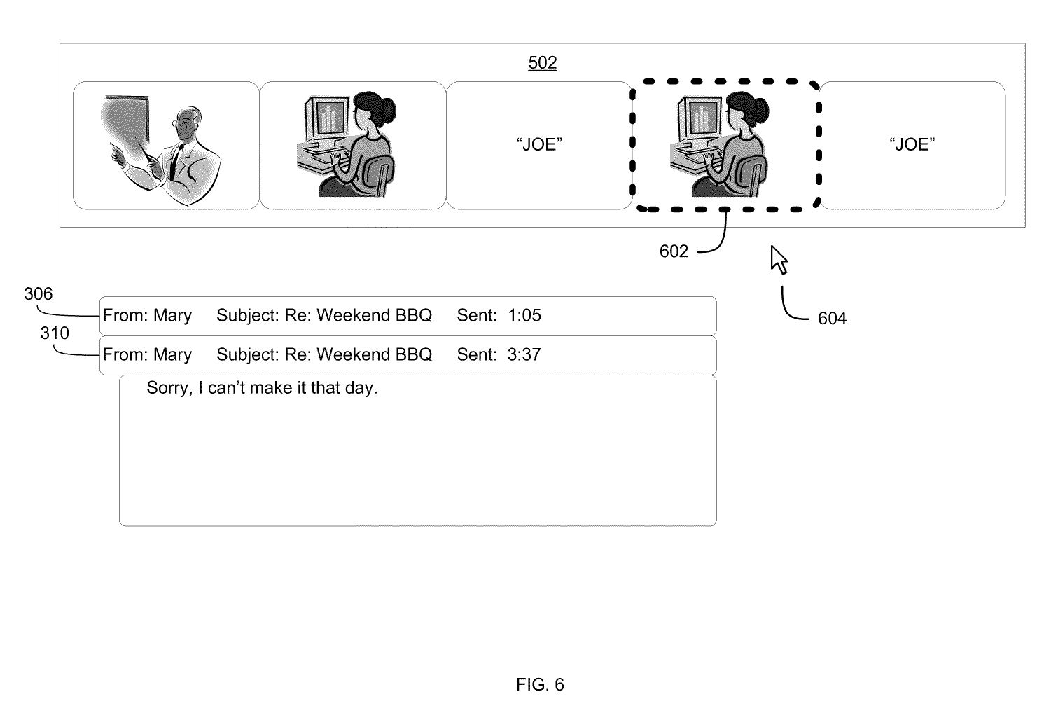

In one example, a user may wish to view all the email messages in email string 302 sent by Mary. Turning to FIG. 6, the email user may select sender file 602, the image associated with Mary. The email user may, for example, use on screen pointer 604 to click on and select sender file 602, as shown by the dotted line around sender file 602. However, various methods of selecting sender file 602 may be used. For example, various user interface elements, such as buttons, drop down boxes, check boxes, radio buttons, and the like may be used to select sender file 602.

If a user selects a particular sender file, email navigation process 10 may perform 215 an action. In general, performing 215 an action in response to a user's selection of a particular sender file may include any appropriate action. For example, the action may include playing a sound, playing a video, displaying an error message, displaying a “not authorized” message if the user is not allowed to access an email, or any other appropriate action. For example, email navigation process 10 may jump to the email associated with the selected sender file. As shown in FIG. 6, a user has selected the second sender file associated with Mary. In response, email navigation process 10 has jumped to the second email from Mary, and has opened and displayed the second email from Mary.

Additionally/alternatively, if a user selects an email sender file, email navigation process 10 may also display 216 all the email messages sent by the user associated with the selected sender file. As discussed, in FIG. 6, a user has selected the sender file associated with Mary. Accordingly, email navigation process 10 may display 216 email messages 306, 310, i.e. the email messages from email string 302 sent by Mary. In this way, a user may be able to filter out email from senders other than Mary, and view only the email messages sent by Mary.

The methods and computer program products claimed may be used, for example, to provide a visual representation of email senders in an email string. The methods and systems claimed may also be used, for example, to provide an email user with a means for filtering email messages in an email string.

A number of implementations have been described. Nevertheless, it will be understood that various modifications may be made. Accordingly, other implementations and other uses are within the scope of the following claims.

What is claimed is:

1. A method of navigating email comprising:
receiving, on an email server, an email thread including a sequence of email messages;
identifying, by the email server, a sender of each email message in the sequence of email messages;
identifying, by the email server, at least one sender file associated with at least one identified sender of the email messages in the sequence of email messages, the at least one sender file configured to provide a visual identification of the at least one identified sender;
generating, by the email server, a sequence of sender files from the at least one sender file, the sequence of sender files having an order corresponding to an order of the sequence of email messages; and
displaying the sequence of sender files on a computer display.

2. The method of claim 1 wherein the at least one sender file is chosen from the list comprising:
an icon representing the at least one identified sender;
a photo of the at least one identified sender;
a symbol representing the at least one identified sender; and
a media file representing the at least one identified sender.

3. The method of claim 1 further comprising:
replacing at least one of the at least one sender files with a replacement sender file, the replacement sender file configured to provide a visual identification of the at least one identified sender.

4. The method of claim 1 wherein each email message in the sequence of email messages includes common text in a subject line of each email message.

5. The method of claim 1 further comprising:
associating an action with at least one sender file in the sequence of sender files; and
performing the action in response to selection of the at least one sender file.

6. The method of claim 5 wherein the action includes:
identifying the sender associated with the at least one selected sender file; and
displaying the email messages from the sequence of email messages sent by the sender associated with the at least one selected sender file.

7. A method of navigating email comprising:
receiving, on an email client, an email thread including a sequence of email messages;
identifying, by the email client, a sender of each email message in the sequence of email messages;
identifying, by the email client, at least one sender file associated with at least one identified sender of the email messages in the sequence of email messages, the at least one sender file configured to provide a visual identification of the at least one identified sender;
generating, by the email client, a sequence of sender files from the at least one sender file, the sequence of sender files having an order corresponding to an order of the sequence of email messages; and
displaying the sequence of sender files on a computer display.

8. The method of claim 7 wherein the at least one sender files is chosen from the list comprising:
an icon representing the at least one identified sender;
a photo of the at least one identified sender;
a symbol representing the at least one identified sender; and
a media file representing the at least one identified sender.

9. The method of claim 7 further comprising:
replacing at least one of the at least one sender files with a replacement sender file, the replacement sender file configured to provide a visual identification of the at least one identified sender.

10. The method of claim 7 wherein each email message in the sequence of email messages includes common text in a subject line of each email message.

11. The method of claim 7 further comprising:
associating an action with at least one sender file in the sequence of sender files; and
performing the action in response to selection of the at least one sender file.

12. The method of claim 11 wherein the action includes:
identifying the sender associated with the at least one selected sender file; and
displaying the email messages from the sequence of email messages sent by the sender associated with the at least one selected sender file.

13. A computer program product for navigating email, stored on a computer readable medium, having a plurality of instructions stored thereon, which, when executed by a processor, cause the processor to perform operations comprising:
receiving, on an email device, an email thread including a sequence of email messages;
identifying, by the email device, a sender of each email message in the sequence of email messages;
identifying, by the email device, at least one sender file associated with at least one identified sender of the email messages in the sequence of email messages, the at least one sender file configured to provide a visual identification of the at least one identified sender;
generating, by the email device, a sequence of sender file from the at least one sender file, the sequence of sender files having an order corresponding to an order of the sequence of email messages; and
displaying the sequence of sender files on a computer display.

14. The computer program product of claim 13 wherein the at least one sender file is chosen from the list comprising:
an icon representing the at least one identified sender;
a photo of the at least one identified sender;
a symbol representing the at least one identified sender; and
a media file representing the at least one identified sender.

15. The computer program product of claim 13 wherein the operations further comprise:
replacing at least one of the at least one sender file with a replacement sender file, the replacement sender file configured to provide a visual identification of the at least one identified sender.

16. The computer program product of claim 13 wherein the operations further comprise:
receiving a selection of at least one sender file in the sequence of sender files;
identifying the sender associated with the at least one selected sender file; and
displaying the email messages from the sequence of email messages sent by the sender associated with the at least one selected sender file.

17. The computer program product of claim 13 wherein the operations further comprise:
associating an action with at least one sender file in the sequence of sender files; and
performing the action in response to selection of the at least one sender file.

18. The computer program product of claim 17 wherein the action includes:
identifying the sender associated with the at least one selected sender file; and
displaying the email messages from the sequence of email messages sent by the sender associated with the at least one selected sender file.

19. The computer program product of claim 13 wherein the email device is an email client device.

20. The computer program product of claim 13 wherein the email device is an email server device.
